(19) United States
(12) Patent Application Publication
(10) Pub. No.: US 2018/0368454 A1
(43) Pub. Date: Dec. 27, 2018

(54) ENCAPSULATED SWEETENERS AND METHOD FOR PRODUCING SAME

(71) Applicant: Wacker Chemie AG, Muenchen (DE)

(72) Inventor: Thomas WIMMER, Burghausen (DE)

(21) Appl. No.: 16/069,067

(22) PCT Filed: Feb. 22, 2017
(86) PCT No.: PCT/EP2017/054035

§ 371 Date: Jul. 10, 2018

(30) Foreign Application Priority Data
Feb. 25, 2016 (DE) 10 2016 203 008.6

(51) Int. Cl. A23L 27/00; A23L 27/30; A23G 3/36; A23G 4/06; A23P 10/30

(52) U.S. Cl. CPC A23L 27/74; A23L 27/72; A23L 27/30; A23G 3/36; A23V 2300/31; A23P 10/30; A23V 2002/00; A23V 2250/24; A23G 4/06

(57) ABSTRACT

Encapsulated sweeteners and a method for producing same. The invention relates to a composition of encapsulated sweeteners containing 1-40 wt. % of sweetening agents and 60-99 wt. % of vinyl acetate vinyl laurate copolymers, as well as a method for producing same and the use of same in confectionary, medicines or chewing gum.

The invention relates to encapsulated sweeteners and also methods for producing same.

In tooth-friendly chewing gums, the sweet ingredients sugar and glucose syrup are frequently replaced by polyols in crystalline form and in the form of concentrated solutions, e.g. maltitol syrup. Important sugar replacements are polyols, such as, for example, sorbitol, maltitol, isomalt, mannitol, xylitol, erythritol, palatinose or lactitol.

Since the sweetness of polyols is usually lower than that of sugar, additional sweeteners are generally added to sugar-free chewing gums. Sweeteners should be understood to mean compounds that have a much greater sweetness compared to sugar, and little to no nutritional value. Sweeteners include, for example, aspartame, acesulfame K, aspartame-acesulfame salt, sucralose, cyclamate, neohesperidin, saccharin, stevia, alitame, neotame and thaumatin. The sweeteners are used as individual substances or synergistic mixtures.

A disadvantage of sweeteners in chewing gum is that the sweetness is relatively rapidly lost through the process of chewing. A known way of reducing this disadvantage is to delay the release of sweeteners by encapsulation.

Thus, for example U.S. Pat. No. 4,384,004 describes the encapsulation of aspartame with ethyl cellulose, hydroxypropyl cellulose or polyvinylpyrrolidone. The preparation of acesulfame K coated with wax and the use in chewing gum are described in U.S. Pat. No. 4,885,175. Encapsulation with polyvinyl acetate is also known from numerous patents. U.S. Pat. No. 5,169,658 describes the encapsulation of sucralose with heat-softened polyvinyl acetate (molar mass=32 000 g/mol) in a double-Z kneader. The delayed release in chewing gum is detected sensorially and analytically. In example 12 of U.S. Pat. No. 4,997,659, pulverulent alitame and polyvinyl acetate are extruded in a melt-spinning process. U.S. Pat. No. 5,165,944 discloses a method for encapsulating acesulfame K, aspartame or saccharin with polyvinyl acetate (molar mass of 50 000-80 000 g/mol) in an extruder. The spun fibers obtained are comminuted and give rise to a longer-lasting flavor in chewing gum. The encapsulation of aspartame and saccharin in a melted mixture of high molecular weight polyvinyl acetate and glycerol monostearate is described in U.S. Pat. No. 4,711,784.

The preparation of an encapsulated aspartame with polyvinyl acetate and magnesium stearate in an extrusion process is described in U.S. Pat. No. 7,244,454. U.S. Pat. No. 5,000,965 gives a detailed description of the preparation of a pelletized, encapsulated sweetener (acesulfame K) with polyvinyl acetate, partially hydrogenated soybean oil and glycerol monostearate. U.S. Pat. No. 8,828,423 discloses that the release of sweetness depends on the tensile strength of a mixture of high molecular weight polyvinyl acetate, hydrogenated oil, glycerol monostearate and the sweeteners aspartame and acesulfame K.

It is an object of the invention to provide a novel composition of encapsulated sweeteners.

The object is achieved by a composition comprising 1-40 wt % of sweeteners, 60-99 wt % of vinyl acetate-vinyl laurate copolymers.

The composition optionally also comprises 0-10 wt % of additives from the group of emulsifiers and fats.

Preferably, the composition consists of 10-30 wt % of sweeteners and 70-90 wt % of vinyl acetate-vinyl laurate copolymers and 0-10 wt % of additives from the group of emulsifiers and fats.

For the purposes of the invention, sweeteners are aspartame, acesulfame K, aspartame-acesulfame salt, sucralose, cyclamate, neohesperidin, saccharin, stevia, alitame, neotame and thaumatin. Sweeteners may be used alone or in synergistic mixtures. Mixtures of different sweeteners have a known positive effect on the sweetness and an improvement in the flavor profile in use. Aspartame, acesulfame K and sucralose and mixtures of these sweeteners are preferred.

The vinyl acetate-vinyl laurate copolymers used according to the invention preferably have a monomer ratio in the polymer of 1-30 wt % of vinyl laurate and 70-99 wt % of vinyl acetate. Particular preference is given to a monomer ratio in the polymer of 4-15 wt % of vinyl laurate and correspondingly 85-96 wt % of vinyl acetate.

The weight-average molar mass of the vinyl acetate-vinyl laurate copolymers is 10 000-250 000 g/mol, preferably 20 000 to 150 000 g/mol. The weight-average molar mass Mw is determined by means of size exclusion chromatography (SEC) against a polystyrene standard, in THF, at 40° C., flow rate 1.2 ml/min.

According to the invention, use may be made of glycerol monostearate, acetylated glycerol esters of fatty acids, fatty acid esters of sucrose, diacetyltartaric acid esters of monoglycerides, lactic acid esters or citric acid esters of monoglycerides or lecithin as suitable emulsifiers. Preference is given to glycerol monostearate and acetylated glycerol esters of fatty acids.

Suitable fats are unhydrogenated, partially hydrogenated and fully hydrogenated animal fats and vegetable oils, such as, for example, beef tallow, soybean oil, peanut oil, cottonseed oil, palm oil, palm kernel oil, rapeseed oil or sunflower oil.

The inventive compositions may be prepared by melting the copolymer at 70-140° C. and mixing with the sweetener and optionally the additive.

The sweetener may be added here simultaneously or later. The mixing may be carried out continuously or batchwise. For mixing, a heatable double-Z kneader, an extruder, a stirred tank or a planetary mixer may be used.

After mixing, the mass is cooled and comminuted. For this purpose, by way of example, methods such as, for example, pelletization, cutting pelletization, underwater cutting pelletization, crushing, grinding, or cryogenic grinding may be used. If required, the comminuted products may be classified by sieving or air classification.

The compositions according to the invention can be incorporated into different products such as confectionery products, medicinal products, such as, for example, denture adhesives, pharmaceutical preparations, and also cosmetic products, for example toothpaste.

The use in chewing gums is especially suitable, particularly sugar-free chewing gums. Sugar-free chewing gums generally consist of a gum base, polyols, flavors, sweeteners and further additives such as, for example, colorants, antioxidants, emulsifiers, plasticizers and humectants. Polyols which may be used include sorbitol, maltitol, isomalt, mannitol, xylitol, erythritol, palatinose or lactitol or a mixture of one or more of these substances, which in some cases are also available as syrups.

The compositions according to the invention give rise to a delayed release of sweetness, which thereby achieves a longer-lasting flavor of the chewing gum.

The following examples serve to further illustrate the invention:

### Example 1: Preparation of a Vinyl Acetate-Vinyl Laurate Copolymer

3 kg of isopropanol together with 2 kg of vinyl laurate, 38 kg of vinyl acetate and 8 g of t-butyl peroxo-2-ethylhexanoate were initially charged in a stirred tank, and the polymerization was started by means of heating the initial mixture to 72° C. At the start, 8 g of t-butyl peroxo-2-ethylhexanoate were added and, during the polymerization, 100 g of t-butyl peroxo-2-ethylhexanoate in 1200 g of isopropanol were metered in within 5 h. After a further hour, the temperature is increased to 120° C. The tank is subsequently evacuated and solvent and residual monomers were distilled off.

The melt was discharged and cooled. A clear product was obtained, with a monomer composition (wt %) of 95% vinyl acetate and 5% vinyl laurate. The glass transition temperature was determined to be 37° C. using differential scanning calorimetry (DSC). The weight-average molar mass was measured at 105 000 g/mol using SEC (size exclusion chromatography).

### Example 2: Preparation of a Vinyl Acetate-Vinyl Laurate Copolymer

4 kg of isopropanol together with 4.8 kg of vinyl laurate, 35.2 kg of vinyl acetate and 10 g of t-butyl peroxo-2-ethylhexanoate were initially charged in a stirred tank, and the polymerization was started by means of heating the initial mixture to 72° C. At the start, 8 g of t-butyl peroxo-2-ethylhexanoate were added and, during the polymerization, 136 g of t-butyl peroxo-2-ethylhexanoate in 1500 g of isopropanol were metered in within 5 h. After a further hour, the temperature is increased to 120° C. The tank is subsequently evacuated and solvent and residual monomers are distilled off. The melt was discharged and cooled. A clear product was obtained, with a monomer composition (wt %) of 88% vinyl acetate and 12% vinyl laurate. The glass transition temperature was determined to be 32° C. using DSC. The weight-average molar mass was measured at 46 000 g/mol using SEC.

### Example 3: Preparation of an Encapsulate Aspartame

700 g of a vinyl acetate-vinyl laurate copolymer from example 1 were melted in a double-Z kneader at 105° C. Subsequently, 300 g of fine crystalline aspartame were added, the mass was kneaded for a further 10 minutes at 105° C., and was then removed from the kneader. After cooling, the mass is comminuted in a mill. The aspartame concentration was determined to be 30% by HPLC.

### Example 4: Preparation of Encapsulated Sucralose

750 g of a vinyl acetate-vinyl laurate copolymer from example 2 and 50 g of glycerol monostearate were melted in a double-Z kneader at 95° C. Subsequently, 200 g of powdered sucralose were added, the mass was kneaded for a further 10 minutes at 95° C., and was then removed from the kneader. After cooling, the mass is comminuted in a mill. The sucralose concentration was determined to be 20% by HPLC.

### Example 5: Preparation of Encapsulated Acesulfame K

700 g of a vinyl acetate-vinyl laurate copolymer from example 1 were melted with 30 g of glycerol monostearate and 50 g of hydrogenated palm fat in a double-Z kneader at 100° C. Subsequently, 220 g of acesulfame K were added, the mass was kneaded for a further 5 minutes at 100° C., and was then removed from the kneader. After cooling, the mass is comminuted in a mill. The acesulfame K concentration was determined to be 22% by HPLC.

### Example 6: Preparation of a Sugar-Free Chewing Gum (Comparative Example)

A chewing gum mass was prepared from 300 g of a gum base (Valencia T-PL/CAFOSA), 450 g of sorbitol, 108 g of xylitol, 50 g of mannitol, 75 g of maltitol syrup (Lycasin® 80/55), 15 g of mint oil and 2.0 g of aspartame in a double-Z kneader at 54° C. The mass is cooled, rolled out to a thickness of approximately 1 mm and cut into strips of 2 g each.

### Example 7: Preparation of a Sugar-Free Chewing Gum (According to the Invention)

The preparation was carried out as described in example 6, except that the 2 g of aspartame were replaced by 6.67 g of encapsulated aspartame (from example 3).

### Example 8

The chewing gums from examples 6 and 7 were chewed by individual people for 2, 5, 10, 15 and 20 minutes. The remaining chewed mass was analyzed for the remaining aspartame content by HPLC.

The following table clearly shows the delayed release of the sweetener in the formulation according to the invention.

| | Recovery | Recovery |
|---|---|---|
| | of | of |
| | aspartame | aspartame |
| | (example | (example |
| Chewing time | 6) | 7) |
| 0 minutes | 100% | 100% |
| 2 minutes | 93% | 98% |
| 5 minutes | 81% | 95% |
| 10 minutes | 71% | 81% |
| 15 minutes | 50% | 79% |
| 20 minutes | 41% | 69% |

1. A composition of an encapsulated sweetener, comprising 1-40 wt % of the sweetener, and 60-99 wt % of vinyl acetate-vinyl laurate copolymers, wherein: (a) the sweetener comprises at least one member selected from the group consisting of aspartame, acesulfame K and sucralose, and (b) the vinyl acetate-vinyl laurate copolymers have a monomer ratio of 4-15 wt % of vinyl laurate and 85-96 wt % of vinyl acetate.

2. The composition as claimed in claim 1, additionally comprising 0-10 wt % of additives selected from the group consisting of an emulsifier and a fat.

3. The composition as claimed in claim 1, comprising 10-30 wt % of the sweetener, 70-90 wt % of the vinyl acetate-vinyl laurate copolymers and 0-10 wt % of additives selected from the group consisting of an emulsifier and a fat.

4-5. (canceled)

6. The composition as claimed in claim 1, wherein weight-average molar mass of the vinyl acetate-vinyl laurate copolymers is 10,000-250,000 g/mol.

7. The composition as claimed in claim 2, wherein the emulsifier is a member selected from the group consisting of glycerol monostearate, acetylated glycerol esters of fatty acids, fatty acid esters of sucrose, diacetyltartaric acid esters of monoglycerides, lactic acid esters of monoglycerides, citric acid esters of monoglycerides and lecithin.

8. The composition as claimed in claim 2, wherein the fat is a member selected from the group consisting of unhydrogenated, partially hydrogenated and fully hydrogenated animal fats and vegetable oils.

9. A method for preparing a composition as claimed in claim 1, said method comprising:
melting the vinyl acetate-vinyl laurate copolymers at 70-140° C.;
mixing the vinyl acetate-vinyl laurate copolymers with the sweetener to provide a mixture;
cooling the mixture to provide a cooled mixture; and
comminuting the cooled mixture to provide the composition.

10. A method of using the composition as claimed in claim 1, said method comprising incorporating the composition into confectionery products, medicinal products or chewing gums.

11. The composition as claimed in claim 3, wherein a weight-average molar mass of the vinyl acetate-vinyl laurate copolymers is 10,000-250,000 g/mol.

12. The composition as claimed in claim 11, wherein the emulsifier is a member selected from the group consisting of glycerol monostearate, acetylated glycerol esters of fatty acids, fatty acid esters of sucrose, diacetyltartaric acid esters of monoglycerides, lactic acid esters of monoglycerides, citric acid esters of monoglycerides and lecithin.

13. The composition as claimed in claim 12, wherein the fat is a member selected from the group consisting of unhydrogenated, partially hydrogenated and fully hydrogenated animal fats and vegetable oils.

14. A method for preparing a composition as claimed in claim 12, said method comprising:
melting the vinyl acetate-vinyl laurate copolymers at 70 140° C.;
mixing the vinyl acetate-vinyl laurate copolymers with the sweetener to provide a mixture;
cooling the mixture to provide a cooled mixture; and
comminuting the cooled mixture to provide the composition.
